(19) United States
(12) Patent Application Publication
(10) Pub. No.: US 2017/0255347 A1
(43) Pub. Date: Sep. 7, 2017

(54) MULTIUSER ACTIVITY VIEWER

(71) Applicant: Hapara Inc., Redwood City, CA (US)

(72) Inventor: Jan C. Zawadzki, Auckland (NZ)

(21) Appl. No.: 15/440,925

(22) Filed: Feb. 23, 2017

Related U.S. Application Data
(60) Provisional application No. 62/301,890, filed on Mar. 1, 2016.

(51) Int. Cl. G06F 3/0482; H04L 12/24; H04L 29/08; G06F 3/0481; G06F 17/24

(52) U.S. Cl. CPC G06F 3/0482; G06F 3/04817; G06F 17/24; H04L 67/22; H04L 41/22

(57) ABSTRACT

A system and method for analyzing and visualizing the activity of multiple users. The activity may relate to accessing resources, which may cause a user device to generate events that are monitored and analyzed. The events may be aggregated to identify activity of a group of users and displayed using a graphical interface with multiple graphical representations. Each of the graphical representations may correspond to a resource (e.g., web page or textual document) and may include multiple visual elements (e.g., bars). The visual elements may illustrate the quantity of users that have accessed the resource within a specified period of time (e.g., class period) as well as the number of users that are currently or not currently accessing the resource. In one example, the users may be students and the graphical interface may be utilized by a teacher to visualize the activity of a group of students within a classroom.

### RELATED APPLICATIONS

This application claims the benefit of U.S. Provisional Patent Application No. 62/301,890 filed Mar. 1, 2016, entitled “Multiuser Activity Viewer,” which is incorporated herein by reference herein.

### TECHNICAL FIELD

Embodiments of the invention relate generally to analyzing user activity and, more specifically, to a system and method for displaying individual and aggregated user activity relating to one or more resources.

### BACKGROUND

Students in modern teaching environments are often equipped with computers and participate in learning experiences that involve the use of the computers. Teachers typically assign projects to students and analyze the final results. Although teachers may scan or walk through a classroom, this may not provide a clear understanding of the activity of a student or group of students. Determining user activity and distinguishing between favorable activity such as activity related to a project and unfavorable activity outside the scope of the project may be useful.

Often the activity of students before, during and after a project may not be clear to a teacher. Providing a way for a teacher to visualize the activity of a group of students and explore which students are accessing which resources may enhance the teachers understanding of student activity. Enhancing a teachers understanding may enable a teacher to change or customize the learning experience and intervene when appropriate.

### BRIEF DESCRIPTION OF THE DRAWINGS

The present invention is illustrated by way of example, and not by way of limitation, and will become apparent upon consideration of the following detailed description, taken in conjunction with the accompanying drawings, in which like reference characters refer to like parts throughout, and in which:

FIG. 1 is a block diagram illustrating an exemplary system architecture in which embodiments may operate.

FIG. 2 is a block diagram illustrating an arrangement of components and modules corresponding to the exemplary system architecture of FIG. 1.

FIG. 3 illustrates an exemplary graphical interface for a multiuser activity viewer that provides details of aggregate user activity in which embodiments may operate.

FIG. 4 illustrates an exemplary graphical interface providing details of individual and aggregate user activity in which embodiments may operate.

FIG. 5 illustrates an exemplary graphical interface displaying snapshot details associated with flagged activity in which embodiments may operate.

FIG. 6 illustrates a process flow for receiving and aggregating events to determine and display user activity in which embodiments may operate.

FIG. 7 is a block diagram illustrating an exemplary system in which embodiments of the present invention may operate.

### DETAILED DESCRIPTION

Embodiments of the present disclosure are directed to a system and method for analyzing and visualizing the activity of multiple users. The activity may relate to accessing one or more resources and may cause a user device to generate events that may be monitored and analyzed. The events may be aggregated to identify activity of a group of users and displayed using a graphical interface with multiple graphical representations. Each of the graphical representations may correspond to a resource (e.g., web page or textual document) and may include multiple visual elements (e.g., bars). The visual elements may illustrate the quantity of users that have accessed the resource within a specified period of time (e.g., class period) as well as the number of users that are currently or not currently accessing the resource. In one example, the users may be students and the graphical interface may be utilized by a teacher to visualize the activity of a group of students within a classroom.

The graphical interface may be organized in a dashboard manner with multiple regions, which may include an individual user region and a group user region. The individual user region may illustrate the activity of individual users and the applications and resources being accessed by individual users. The group region may illustrate activity of a group of users and may include a portion that graphically represents the quantity of users that have accessed each of a plurality of sources (e.g., web sites, repositories). The group region may also include another portion that graphically represents the quantity of users that have accessed each of a plurality of resources (e.g., assignments, quizzes).

The graphical interface may utilize multiple visual elements to illustrate the quantity of users accessing or not accessing a particular resource. The visual elements may include bars, lines, slices, dots, dashes or other graphical features and may include visual attributes that distinguish the one or more visual elements from one another. The visual elements may be aligned along multiple axes (e.g., horizontal axis and vertical axis). The length the visual element extends along an axis may illustrate the quantity of users in a group (e.g., class). In one example, each of the visual elements may be a bar and may be the same or similar to the bars of a bar chart. The length of each bar may correspond to the number of users associated with a resource during a respective duration of time. One bar may illustrate the total number of users that are currently accessing a resource and another bar may illustrate the total number of users that have accessed a resource since the beginning of a duration of time (e.g., class period) but are not currently accessing the resource.

The graphical user interface may be used to monitor activity and may facilitate intervention or interaction with one or more users. A user may utilize the graphical interface to identify a user or group of users accessing on resources. Some of the resources may be related to assignments or projects and may pertain to the intended activity of the users and other resources may not be related to the intended activity of the user. The graphical interface may enable a user of the graphical interface to identify the users that are accessing the intended resources and the users that are not accessing the intended resource or are accessing other prohibited or discouraged resources. The graphical user interface may identify these users and may enable a user to intervene. The intervention may include sending a message to a user or terminating the user's access to a resource. The intervention may also include flagging the user or the user's activity. The process of flagging may include capturing content from the device of the user and storing it. The content may include an image from the user's device (e.g., screen shot), historical access data (e.g., resource viewer history) or other content associated with the user's activity.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Unless specifically stated otherwise, as apparent from the above discussion, it is appreciated that throughout the description, discussions utilizing terms such as “receiving”, “determining”, “providing”, “monitoring”, “measuring”, “calculating”, “comparing”, “processing”, “retrieving”, “aggregating”, “flagging”, “terminating”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and graphical interfaces presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

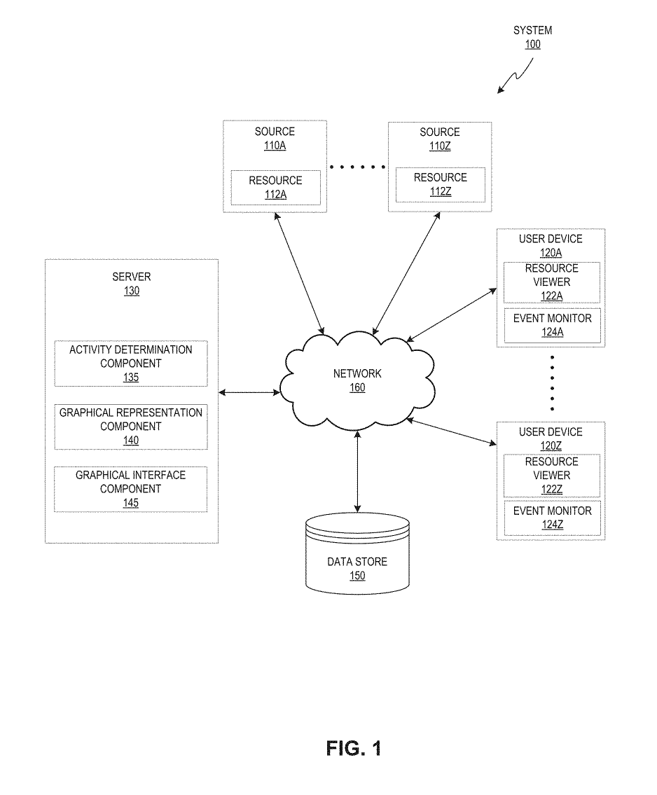

FIG. 1 is a block diagram illustrating exemplary system 100 in which embodiments may operate. Referring to FIG. 1, system 100 may monitor the activity of multiple users and may display a graphical interface that visualizes the activity of the multiple users. System 100 may comprise one or more sources 110A-Z, one or more user devices 120A-Z, a server 130, and a datastore 150, which may each be interconnected with one another via network 160. Network 160 may comprise a private network (e.g., local area network (LAN), wide area network (WAN), intranet) or a public network (e.g., the Internet).

Sources 110A-Z may include one or more resources 110A-Z that are accessible to user devices 120A-Z. Sources 110A-Z may include resource providers such as web sites, document repositories, media services, content sharing services or other content providers. Resources 110A-Z may be remote resources as shown in FIG. 1 and may be hosted on a device that is separate from the user devices 120A-Z by one or more network connections. In other examples, sources 110A-Z may be local sources that are local to either server 130 or user devices 120A-Z or may be a combination of remote and local sources.

Resources 110A-Z may include textual data, audio data, image data (e.g., pictures or videos) or other media. Resources 110A-Z may take the form of a web page, textual file, picture, video or other document capable of being interpreted by a user device and presented to a user. A resource may include a web document (e.g., HTML document; web page) or a textual document (e.g., Google Doc®, Microsoft Word® document, Apple Pages® document, Open Office® document, Portable Document Format® document (PDF)) or any other document format or file format capable of being stored in a data store. A resource may include multiple resources of varying type such as text, audio, pictures, video or any type of media.

User devices 120A-Z may include a user interface and one or more processing devices. In one example, user devices 120A-Z may include a computing device that is mobile or stationary such as a laptop, notebook, tablet, phone, desktop, server or other devices. Each user device 120A-Z may be associated with one or more users, for example, a user may have a notebook and a smartphone. In addition, a single user device 120A may be associated with multiple users. For example, multiple users may share user device 120A or may remotely access or log-into a single user device 120A, similar to a terminal server configuration. Each of the user devices 120A-Z may include one or more resource viewers 122A and one or more event monitors 124A.

Resource viewers 122A-Z may be configured to present (e.g., display, announce) resources 110A-Z to one or more users. Resource viewers 122A-Z may be any program or feature of a user device that provides the user access to resources 110A-Z. Resource viewers 122A-Z may be the same or similar to an internet browser or may be an application executing within an internet browser (e.g., web application). Resource viewers 122A-Z may also be local applications (e.g., native application) installed on a user device and may include a document editor, a word processor, an image editor, or other software application. When a user performs an activity, the resource viewers 122A-Z or user devices 120A-Z may generate events that may be monitored by event monitors 124A-Z.

Event monitors 124A-Z may be modules or features of the resource viewer or user device. Event monitors 124A-Z may monitor, track or audit events which may be used to determine activity of a user. Each event may include information for identifying an activity associated with the user (e.g., user account), the user device, the resource or a combination thereof. The activity may include any action initiated by a user and may include opening, closing, viewing, modifying or other action affecting a program, source or resource. In one example, a user may access an online textual document hosted on a remote repository and an event may be generated when the document is opened, when the document is closed and when the user accesses the document. In another example, a user may access a web page document (i.e., resource) hosted on a web site (i.e., source) and an event may be generated when the user contacts the web site, requests the web page document, views the web page document or closes the web site access. In a further example, a use may access a program using the user device and an event may be generated when the user launches the program, accesses the program or closes the program. These are intended to be example events and there may be more or less events generated as a result of the actions discussed above.

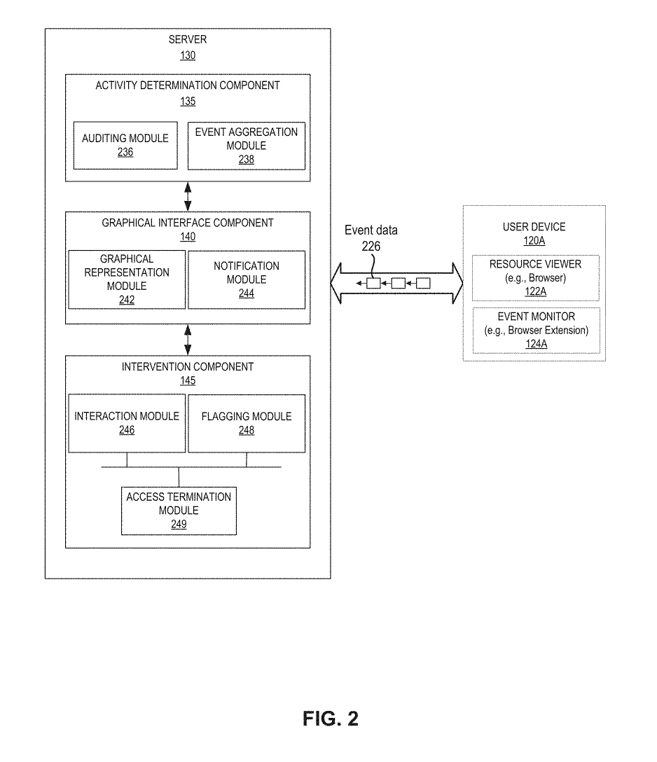

Server 130 may be a computing device that is capable of receiving event data from one or more user devices 120A-Z and processing the event data to identify the activity of one or more users. Server 130 may be a separate computing device as shown in FIG. 1 or may be integrated with one or more of source 110A-Z or user devices 120A-Z. Server 130 may include an activity determination component 135, a graphical interface component 140 and an intervention component 145. Activity determination component 135 may receive and analyze event data from one or more user devices 120A-Z. The analysis of the event data may allow the server to identify which users are accessing which resources and when the access occurs or does not occur. Graphical interface component 140 may receive information from activity determination component 135 and may generate one or more graphical interfaces for presenting and summarizing the activity. Intervention component 145 may interact with the graphical interface component 140 to enable a viewer of the graphical interface to interact with or store information about one or more of the users. The components of server 130 and their interactions will be discussed in more detail in regards to FIG. 2.

FIG. 2 is a block diagram of an arrangement of components and modules of user device 120A and server 130 and communication between user device 120A and server 130, as illustrated in system 100 of FIG. 1. System 100 may include a user device 120A that transmits event data 226 to server 130. Server 130 may receive event data 226 and may process event data 226 using an activity determination component 135 that may include an auditing module 236 and an event aggregation module 238. Server 130 may also include a graphical interface component 140 with a graphical representation module 242 and a notification module 244 as well as an intervention component 145 with an interaction module 246, a flagging module 248 and an access termination module 249.

User device 120A may include a resource viewer 122A and an event monitor 124A, as discussed above, and in one example resource viewer 122A may be a browser and event monitor 124A may be an extension or plug-in for the browser. The browser may be any software application capable of viewing or accessing resources (e.g., web page document, textual documents) and may be the same or similar to an internet browser such as Google Chrome®, Apple Safari®, Microsoft Internet Explorer®, Mozilla Firefox® or other browser. A user may utilize the resource viewer 122A to access resources during a learning exercise. In one example, a student may utilize resource viewer 122A to access a resource containing an assignment and access one or more other resources to participate or complete the assignment. In another example, a teacher may utilize the resource viewer 122 to access a resource (e.g., web page or interface document) that provides a graphical user interface with graphical representations of the individual and aggregate user activity. The resource viewer 122A may include an event monitor 124 in the form of a browser feature that may be native to the browser or an extension of the browser. The browser feature may be implemented in any computer based language such as java script, java, C, C++ or other programming language. The browser features may monitor events generated from user activity and generate event data 226.

Event data 226 may include information corresponding to the activity of the user device and may be transmitted to server 130 for analysis. Event data 226 may include information that identifies users, resources or actions or may include information that is used to identify (e.g., resolve) the users, resources and actions. The actions may be related to web sites, documents or programs and may be associated with computing operations (e.g., commands) related to opening, closing, accessing, viewing, modified or other operation of user device 120. Event data 226 may include the actual events or copy of the actual events generated by the user device or may include information summarizing the events that occurred on user device 120 or a combination of both. Event data 226 may be transmitted to server 130 as one or more individual messages, a burst of messages (e.g., group of messages every few seconds or minutes), a stream of messages (e.g., activity stream or event stream) or a combination thereof.

Server 130 may receive event data 226 from multiple user devices 120 and may process event data 226 to identify the activity of multiple users. Server 130 may organize and store the event data 226 for concurrent or subsequent processing. Server 130 may store event data 226 in a format that is the same or similar to the format in which it was received or may encode/decode or compress/uncompress event data 226 before, during or after storing event data 226. Server 130 may process event data 226 using activity determination component 135. Activity determination component 135 may include auditing module 236 and event aggregation module 238.

Auditing module 236 may receive event data 226 and may analyze event data 226 to determine the users, resources and actions represented by event data 226. Determining the user may involve inspecting the event data 226 for information that relates to a user device or user account that is associated with a user. Information related to the user device may include a device name, a device ID, a network address (e.g., IP address, MAC address, port number) or other device identification data. Information related to the user account may include an account name, account ID, session ID, token or other data that can be used to identify a user. Determining the resource may involve inspecting the event data 226 for information related to a resource or source, such as, a universal resource locator (URL), document name, file name, command parameters, or other information. Determining the action may involve inspecting the event data 226 for information that relates to a command or operation initiated or generated as a result of user activity.

Event aggregation module 238 may receive processed event data from auditing module 236 and may organize and summarize the event data 226. Event aggregation module 238 may organize the event data by resource, user, action or a combination thereof. In one example, event aggregation module 238 may aggregate the users and the actions associated with a specific resource and may temporally group the users based on when the users accessed the resource. A temporal group may include the users that accessed or did not access the resource during a specific duration of time. The specific duration of time may be based on any predefined duration of time which may be defined based on a number of seconds, minutes, hours, days, weeks, months, years, semesters, grade or other period of time. The specific duration of time may be based on a relative time range (e.g., past 10 minutes) or an absolute time range (e.g., 2 pm-3 pm) and may repeat (e.g., 2 pm-3 pm Monday, Wednesday and Friday).

Server 130 may provide a display of the event data 226 processed by activity determination component 135 using graphical interface component 140. Graphical interface component 140 may include a graphical representation module 242 and notification module 244.

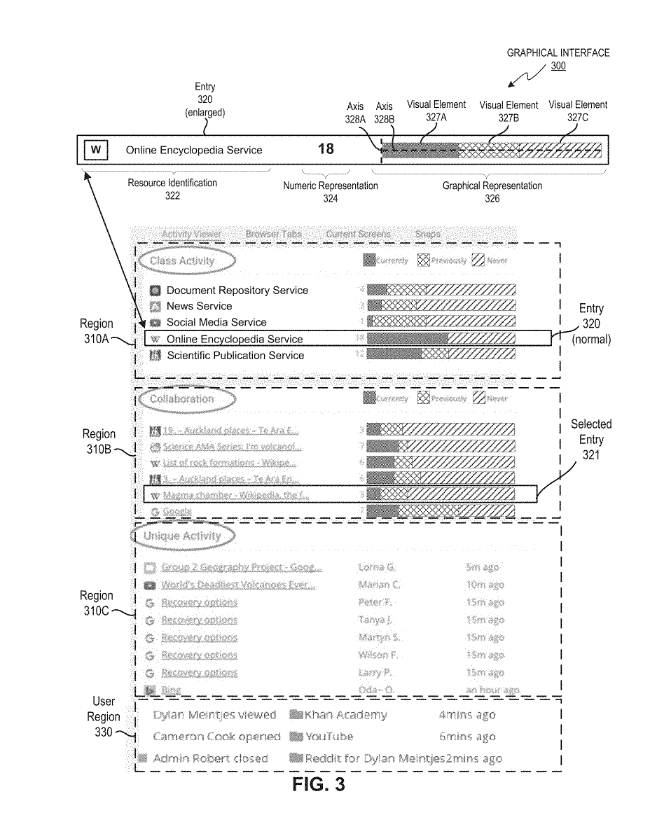

Graphical representation module 242 may generate a graphical interface including one or more graphical representations that illustrate the aggregate activity of the users. The graphical interface may illustrate the quantity of users accessing or not accessing a particular resource using a graphical representation with multiple visual elements. The visual elements may include bars, lines, slices, dots, dashes or other graphical features capable of graphically displaying information and may include visual attributes that distinguish the one or more visual elements from one another. Graphical representation will be discussed in more detail below in regards to FIG. 3.

Notification module 244 may include features that can be configured to notify a user if one or more actions occur. The notification may be in the form of an alert that is generated when one or more triggering conditions are satisfied. A triggering condition may be based on the quantity of users that have performed an action or have not performed action and may be based on a duration of time. In one example, a notification may be configured to alert a teacher when at least one user has failed to access a resource within a predefined period of time (e.g., within 15 min of a quiz, class or assignment beginning). In another example, a notification may be configured to alert a teacher when the quantity of users accessing resources not associated with a current assignment exceeds a threshold. This latter notification may be useful for detecting when users are distracted or cheating. For example, the users may be communicating with one another by accessing a mutual resource, such as a shared document, to send messages to one another. Notification module 244 may be integrated with or communicate with intervention component 145.

Intervention component 145 may interact with the graphical interface component 140 to enable a viewer of the graphical interface to interact with or store information about one or more of the users. In one example, intervention component 145 may provide features that enable a user (e.g., teacher) to intervene with one or more users to enhance or alter their learning experience. Intervention component 145 may include a flagging module 248, an interaction module 246 and an access termination module 249.

Flagging module 248 may enable a user to flag activity of one or more users while the activity is occurring or after it has occurred. A flag operation may trigger the retrieval of content from user device 120A, server 130 or a combination of both. The content retrieved in response to flagging operations may include current content, future content, historical content or a combination thereof. The content captured may enable a viewer of the graphical interface to identify an activity, a user and a resource as well as provide a context for the activity, such as what occurred before, during, and after the activity. The content may include information about accessed sources (e.g., web sites, repositories), resources (e.g., web pages, textual documents), applications or a combination thereof. The content may include one or more images of the user device such as a picture or video clip of the user's desktop or of one or more applications executing on the user device. In one example, a teacher may initiate a flagging operation and the flagging module 248 may transmit a request to the user device 120. User device 120 may gather events related to one or more sources, resources or applications. The events may include historical events, which may have occurred prior to the initiation of the flagging operation but may be associated with the same user, resource or source. Flagging module 248 may organize content as one or more snapshot data structures. Each snapshot data structure may correspond to a flag operation and store some or all of the content retrieved in response to the flag operation.

Flagging the activity of a user may be advantageous because it may gather content that may be analyzed to determine whether an intervention is appropriate. The analysis may occur in response to the flag operation or may be performed at a later time, such as after a class or semester has concluded. The analysis may be performed by server 130, by user device 120, by a teacher or a combination of thereof. The analysis of the content may be fully autonomous without any user input or may only require the user to initiate the analysis (e.g., at the end of the semester). The analysis of the flagged user activity may include classifying the activity within one or more categories. The categories may relate to proper and improper behavior and may include categories related to non-participation, delayed participation, prohibited access, improper communication, or other category reflecting intended or unintended activity.

Interaction module 246 may include features that enable a user of the graphical interface to interact with one or more user devices 120. The interaction module may enable a user, such as a teacher, to communicate with one or more users or groups of users (e.g., class of students). The communication may be in the form of instant messages, email, text messaging or other forms of communication. Each communication may include textual messages, audio messages, pictorial messages, video messages or a combination thereof. The communication may be one-way communication (e.g., teacher to student) or two-way communication (e.g., teacher to student and student to teacher). In one example, a teacher or instructor may initiate interaction module 246 to provide guidance, clarification or comments in regards to a resource or activity of a student. In another example, students may initiate interaction module 246 to request guidance, clarification or comment on a resource or on their activity. Interaction module 246 may automatically send messages in response to an activity being flagged or may pre-populate a message with text so that a user of the graphical interface can select if or when to transmit the message. Interaction module 246 may also provide message suggestions (e.g., templates) to the user and based on the user's selection may populate the message, which may include substituting in content (e.g., user name, source location, resource title) into the message.

Access termination module 249 may integrate with interaction module 246 and graphical interface component 140 and may enable communication (e.g., a request) that terminates activity on a user device. Access termination module 249 may receive input from graphical interface component 140 that identifies activity. The activity may be identified by providing information related to a user, resource, source or application. In response to receiving the identified activity, the access termination module 2 may send a signal or request to terminate, exit, close, log-off, suspend or perform any other action or actions. The request may modify the access or use of the user account, user device, resource, source, application or other functionality available to the user. For example, terminating an activity may involve terminating an application (e.g., closing resource viewer), terminating a feature within an application (e.g., closing a tab of an internet browser), terminating access to a source (e.g., blocking web site), terminating user account (e.g., logging-out the user) or other action.

FIG. 3 illustrates an exemplary graphical interface 300 for a multiuser activity viewer that provides individual user activity as well as aggregate multiuser activity, in which embodiments may operate. Graphical interface 300 may illustrate the activity of a group of users and organize the activity based on the resources being accessed. Graphical interface 300 may include multiple regions such as regions 310A-C and user region 330. Regions 310A-C may include one or more entries 320 for illustrating the users that have accessed a specific resource and when the access occurred.

Each of the entries 320 may include a resource identification 322, a numeric representation 324 and a graphical representation 326. Resource identification 322 may identify the resource by providing the name of the resource or the source of the resource. This may be displayed as a textual label or graphical label or a combination of both. For example, there may be a textual portion that displays the name of the source (e.g., “Wikipedia”) and there may be a graphical image (e.g., thumbnail, icon) associated with the resource. There may also be one or more numeric representations 324 that illustrate the number of users (e.g., user accounts) that have accessed the resource. In the example shown in FIG. 3, the numeric representation is the value 18, which indicates the total number of users that are currently accessing the resource.

Graphical representation 326 may comprise multiple visual elements 327A-C for illustrating the quantity of users accessing a source or resource. Visual elements 327A-C may be aligned along axes 328A and 328B, which may have any orientation (e.g., horizontal (0°), vertical (90°), or any angle or combination of angles (e.g., 45°). In the example shown in FIG. 3, each of the visual elements 327A-C may be a bar and may be the same or similar to bars of a bar chart. The length of the bar graph (e.g., combination of visual elements 327A-C) may represent the total number of users associated with a group (e.g., class). The length of each of the visual elements 327A-C may correspond to the total number of users associated with particular actions or lack of actions within a specific duration of time.

In one embodiment, visual elements 327A-C may include consecutive non-overlapping visual elements that are adjacent to one another. For example, visual element 327A may represent the number of users that are currently accessing a resource or have previously accessed the resource within a duration of time (e.g., past one or more seconds or minutes). Visual element 327B may illustrate the number of users that have accessed the resource since the beginning of a period of time (e.g., class period) and may no longer be accessing the resource or have not accessed the resource within the most recent duration of time (e.g., past one or more seconds). Visual elements 327A and 327B may together indicate the total number of users that have accessed the resource since the beginning of a period of time (e.g., class period). Visual element 327C may illustrate the number of remaining users that are not currently accessing the resource and have not accessed the resource since the beginning of the period of time (e.g., class period).

In an alternate embodiment, visual elements 327A-C may be overlapping visual elements or a combination of overlapping and non-overlapping visual elements. Each of the visual elements 327A-C may begin at the same point on axis 328B, such as at an origin where axis 328A and axis 328B intersect. Visual element 327A may illustrate the number of users that have accessed a resource since the beginning of a period of time (e.g., class period) and visual element 327B may illustrate the total number of users that are currently accessing or have previously accessed the resource since the beginning of a time period (e.g., class period). Visual element 327A may have a length that is shorter than the length of visual element 327B and may be displayed on top of or as an overlay above visual element 327B. The portion of visual element 327B that extends beyond visual element 327A (e.g., exposed or visible portion) may represent the quantity of users that have accessed the resource since the period began but are no longer accessing the content item. In this embodiment, visual element 327C may illustrate the total number of users within a group and the difference between visual element 327B and 327C (e.g., visible portion) may illustrate the number of remaining users that are not currently accessing the resource nor have they accessed the resource since the beginning of the period of time (e.g., class period).

Resource regions 310A-C may be used to organize multiple graphical representations based on an amount of collaboration, type of resource being accessed or a type of source being accessed. As discussed above, the resources may take the form of web pages, text files, pictures, videos and may be received from one or more sources (e.g., web sites, repositories). Each of the regions 310A-C may be associated with one or more types of resources or types of sources. There may be any number of regions corresponding to any number of resource types or source types and the types associated with a region may be predetermined by the product designer or configurable by an administrator or user.

In the example shown in FIG. 3, regions 310A-C may correspond to the amount of collaboration associated with the one or more resources. For example, region 310A (e.g., “Class Activity”) may display most (e.g., all) of the resources that are being accessed or have been previously accessed by at least one user. Region 310B (e.g., “Collaboration”) may list only those resources that are being accessed or have been accessed by at least two users at the same time or during an overlapping time duration and may therefore be associated with collaboration between users. Region 310C (e.g., “Unique Activity”) may display the resources that are being accessed by only a single user and are not accessed by more than one user. Region 310C may provide information that may make it easier for a viewer to discover which users are exploring or working alone and therefore are not collaborating with any other users.

In another example, region 310A may correspond to resources (e.g., web page documents) from a first type of source (e.g., web sites) and resource region 310B may correspond to resources (e.g., textual documents) from a second type of source (e.g., document repository). Each of the entries within region 310A may correspond to a different source but may share the same source type (e.g., web service). For example, there may be entries for: a document repository service (e.g., Google Drive®, Dropbox®, Apple iCloud®); a social media service (e.g., Facebook®, Instagram®, Snapchat®); a news service (e.g., Reddit®, Wall Street Journal®, Yahoo News®); an online encyclopedia service (e.g., Wikipedia®, Britannica®); a scientific publication service (e.g., Discovery Channel®, Popular Science®) or other resource provider. Each entry may identify the source and have a numeric representation for the total number of users that are currently accessing the resource or have accessed the source since the beginning of a class period. The entry may also include a graphical representation that illustrates the total number of students in the class, the number of students that have accessed the source since the class began, and the number of students that have accessed the source in the past preselected duration of time (e.g., five minutes). Region 310B may display aggregate user activity corresponding to textual documents (e.g., web documents). Each of the resource entries may correspond to a different textual document. Some of the textual documents may be assignments that describe a learning activity and others may be textual documents that are unrelated to an assignment.

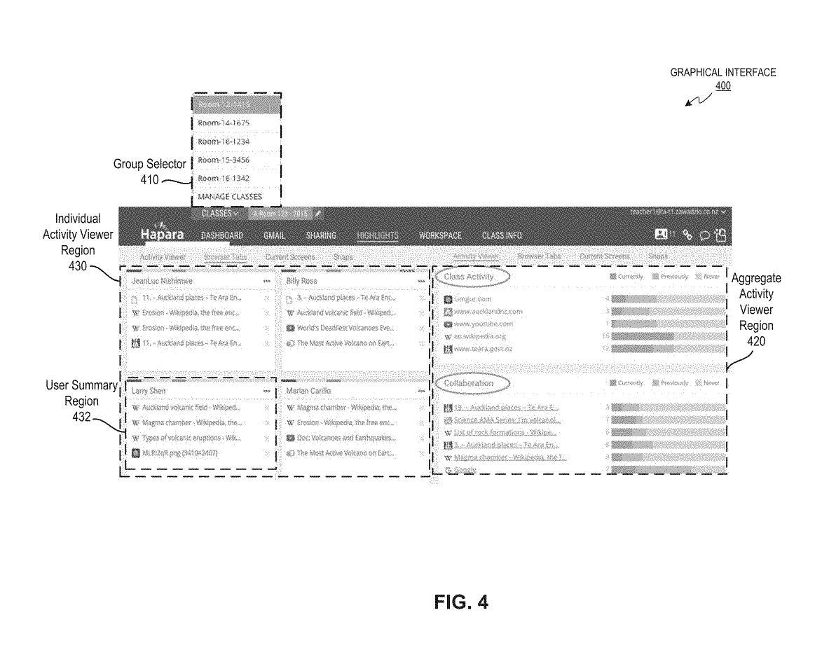

User region 330 may display the users that are associated with one or more of the entries. For example, a viewer of the graphical interface 300 may select an entry corresponding to a resource to display each of the users that have accessed the resource. Each entry within user region 330 may correspond to a specific user and may display information related to the user's activity. The information may include the user's name (e.g., “Cameron Cook”) and resource/source (e.g., “YouTube”). The entry may also include a recent action performed by the user (e.g., “opened”) and the time the action occurred (e.g., “6 min ago”). FIG. 4 illustrates an exemplary graphical interface 400 for displaying individual user activity and aggregate user activity for a group of users, in which embodiments may operate. Graphical interface 400 may include a group selector 410, an aggregate activity viewer region 420 and an individual activity viewer region 430. As shown in FIG. 4, aggregate activity viewer region 420 and individual activity view region 430 are displayed within the same graphical interface, however, in other examples these regions may be on different graphical interfaces (e.g., separate screens).

Group selector 410 may enable a viewer to select a group so that the activity of that group is displayed. Group selector 410 may be any graphical control element capable of receiving input to identify a group. Group selector 410 may display one or more available groups from which a viewer may select. Each of the groups may be associated with one or more users and may represent a class. The groups may be organized based on classroom, subject, grade, section, school, district or other organizational unit. In the example shown in FIG. 4, the group selector 410 includes a drop down menu that lists multiple groups (e.g., Room 12-115, Room 14-1675) and an option for managing the groups (e.g., “Manage Classes”). Once a viewer selects a group from group selector 410 the aggregate activity viewer region 420 and individual activity viewer region 430 may be updated to illustrate activity associated with the selected group.

Aggregate activity viewer region 420 may be the same or similar to graphical interface 400 and its size or location may vary during use. In one embodiment, aggregate activity viewer region 420 may be hidden or displayed by selecting one or more control elements. For example, a user may select a menu item (e.g., “Activity Viewer”) to display aggregate activity viewer region 420 or may select a different menu item (e.g., “Browser Tabs”) to hide aggregate activity viewer region 420. In an alternate embodiment, the size of aggregate activity viewer region 420 may vary based on user input and a user may minimize or hide the aggregate activity viewer region 420. When hidden, aggregate activity viewer 420 may be represented as a thin bar or icon along the perimeter (e.g., left side, bottom) of graphical interface 400. When the aggregate activity viewer region 420 is in a minimized or hidden mode the user may select the thin bar or icon to subsequently display it. In the example shown in FIG. 4, the aggregate activity viewer region 420 is displayed as a windowpane or panel along a right portion of the screen and occupies approximately fifty percent of the screen area. In other examples, the aggregate activity viewer region 420 may be any size or proportion of the screen (e.g., 0-100%) and may be positioned at any portion of the screen (e.g., right, left, middle bottom, top, center).

Individual activity view region 430 may include one or more user summary regions 432 that represent users within the selected group. Each user summary region 432 may correspond to a specific user and may display the name of the user along with applications, sources or resources that have been accessed on the user's device. In the example shown in FIG. 4, user summary region 432 corresponds to the user “Larry Shen” and illustrates that the user device is accessing four resources, which may include three Wikipedia articles corresponding to “Auckland volcanic field,” “Magma chamber,” “Types of volcanic eruptions,” and may also be accessing a picture entitled MLR12qR.png Each of these resources may be accessed using a single instance of a resource viewer, such as a resource viewer with multiple tabs. Alternatively, the resources may be accessed using multiple different resource viewers that are different instances of the same resource viewer or are based on different applications. For example, the “Wikipedia” entries may correspond to internet browsers and the picture entry may correspond to an image editor. User summary region 432 may also include graphical control elements for initiating features of intervention component 145 (e.g., email).

Each user summary region 432 may be positioned in an arrangement that represents the geographical location of the users. For example, the users may be seated in a classroom having rows and columns and the user summary regions 432 may be arranged in grid like manner on the screen with similar rows and columns and a user in the first row and first column of the classroom may have a corresponding user summary region 432 in an upper left portion of the individual activity view region 430.

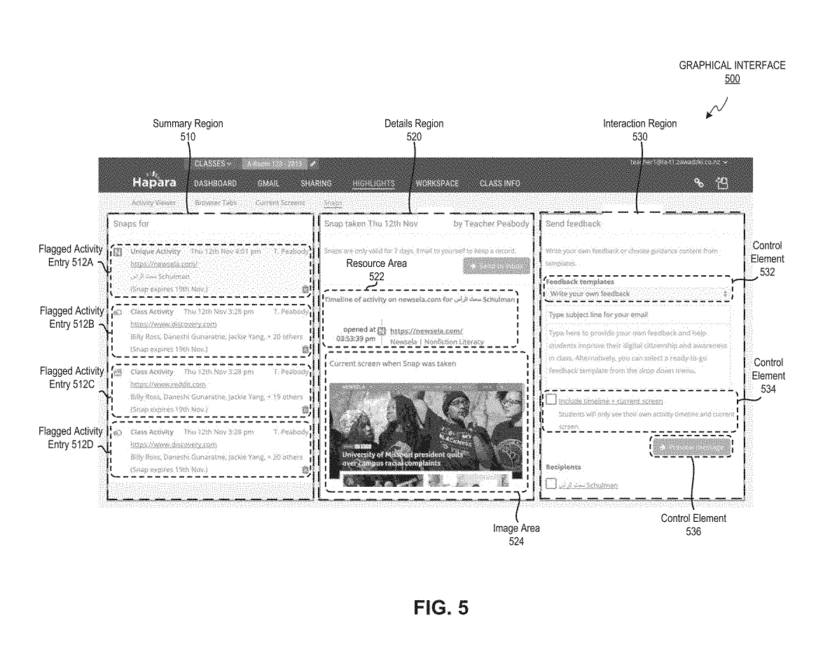

FIG. 5 illustrates an exemplary graphical interface 500 for viewing activity that has been flagged in which embodiments may operate. As discussed above, when an activity is flagged the flagging module may retrieve content related to the flagged activity and may organize and store it as a snapshot (e.g., “Snap”). Graphical interface 500 may enable a user (e.g., teacher) to view the snapshots and the content associated with each of the snapshots. Graphical interface 500 may include a summary region 510 that may display one or more snapshots, a details region 520 that may display the details of at least one of the snapshots, and an interaction region 530 for interacting with a user associated with the snapshot.

Summary region 510 may include one or more flagged activity entries 512A-D. Each of flagged activity entries 512A-D may correspond to a snapshot that includes content retrieved by a flagging module. Each flagged activity entry 512A-D may display information associated with the snapshot such as a source or resource identifier (e.g., name, domain, URL), a name of the active user (e.g., user account display name), a time the flag operation was initiated, a name of the flagging user (e.g., teacher) or other information associated with the user, resource or application. In the example shown, flagged activity entry 512A identifies that the flagged activity was associated with the student “Schulman,” that the (re)source is “https:/newsela.com/,” and the flag operation was initiated by “Teacher Peabody” at “Thu 12^{th} Nov 4:01 pm.” Each of the flagged activity entries 512A-D may include a graphical control element (e.g., trashcan icon or “x” symbol) that enables a user to remove or hide the flagged activity entry and the associated snapshot. Summary region 510 may enable a user to select one or more of the flagged activity entries 512A-D, which may update details region 520.

Details region 520 may display the content of a snapshot associated with the selected flagged activity entry (e.g., 512A) and may include a resource area 522, an image area 524 and an interaction control element 526. Resource area 522 may display information for the resource such as a resource label and an icon representing the resource type (e.g., web domain, text document, slide, spreadsheet, webpage, and video). Image area 524 may display one or more images related to the flagged activity such as one or more screen shots or video clips from the user's device.

Interaction region 530 may display features that enable a user of graphical interface 500 to interact with one or more users or user devices. A viewer (e.g., teacher) may communicate with one or more users or groups of users (e.g., class of students) in the form of instant messages, email, text messaging or other forms of communication. Each communication may include textual messages, audio messages, pictorial messages, video messages or a combination thereof.

In the example shown in FIG. 5, interaction region 530 may include control elements 532, 534 and 536. Control element 532 may enable a viewer to select a feedback template from a list (e.g., drop down menu). The feedback template may include message suggestions that may include default text that may be modified by the user and may substitute content (e.g., user name, source location, resource title) into the message after the selection is made. Control element 534 may enable a viewer to include a time line of the receiving user's activity and an image (e.g., screen shot) of the user's activity within the message. Control element 536 may enable the viewer of graphical interface 500 to preview the resulting message prior to transmitting it to the intended recipient, which may include the user associated with the flagged activity.

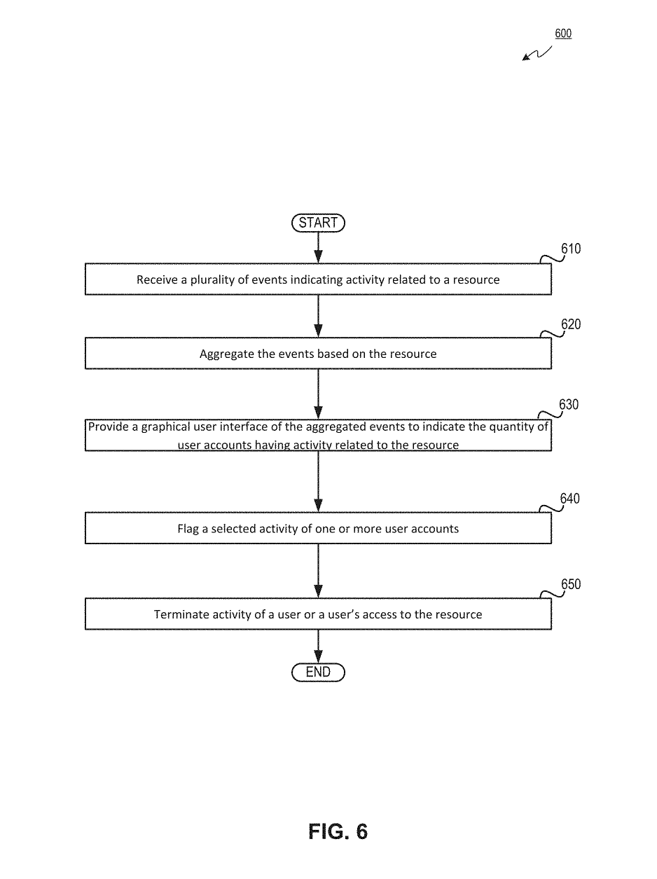

FIG. 6 illustrates a process flow of exemplary method 600 for receiving and aggregating events to determine and display user activity, in which embodiments may operate. Method 600 may be performed by processing devices that may comprise hardware (e.g., circuitry, dedicated logic), software (such as is run on a general purpose computer system or a dedicated machine), or a combination of both. Method 600 and each of the individual blocks, functions, routines, subroutines, or operations may be performed by one or more processors of the computer device executing the method. In certain implementations, method 600 may be performed by a single computer system (e.g., server, user device). Alternatively, method 600 may be performed by two or more computer systems (e.g., server and user device), each computer system executing one or more individual functions, routines, subroutines, or operations of method 600.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Referring to FIG. 6, method 600 may be performed by processing devices of a server device or a client device and may begin at block 610. At block 610, the processing device may receive a plurality of events indicating activity related to a resource. The events may be associated with multiple user accounts and comprise one or more actions related to the resource. The resource may comprise at least one of a web page, a textual document, or a video, and the action related to the resource may comprise at least one of an open event, an access event, a viewing event, an editing event or a close event.

At block 620, the processing device may aggregate the events based on the resource. As discussed above in regards to event aggregation module 238, the processing device may receive event data and may organize and summarize the event data. The processing device may organize the event data by resource, source, user, action or a combination thereof. In one example, the processing device may aggregate the users associated with a specific resource and may temporally group the users based on when the users accessed the resource. A temporal group may include the users that accessed or did not access the resource during a specific duration of time. The specific duration of time may be based on any predefined duration of time which may be defined based on a number of seconds, minutes, hours, days, weeks, months, years, semesters, grades or other duration of time. The specific duration of time may be based on a relative time range (e.g., past 10 minutes) or an absolute time range (e.g., 2 pm-3 pm) and may repeat (e.g., 2 pm-3 pm Monday, Wednesday and Friday).

At block 630, the processing device may provide a graphical user interface comprising one or more graphical representations of the aggregated events to indicate the quantity of user accounts having activity related to the resource. The graphical interface may include a first graphical representation representing the user accounts accessing a web site and a second graphical representation representing the user accounts accessing a textual document. The graphical user interface may comprise a first region that displays the graphical representations and a second region that displays each user account associated with a selected graphical representation. The second region may comprise, for each respective user account, at least one of a name of the user account, a name of the resource, a name of the source of the resource, a recent event, or a relative time of the recent event.

Each graphical representation may represent a numeric value indicating a total number of user accounts having activity related to the resource during a preselected duration of time. The preselected duration of time may be equal to the duration of a class period. The graphical representation may comprise multiple adjacent visual elements, such as a first visual element representing a quantity of user accounts that are currently accessing the resource and a second visual indicator indicating a quantity of user accounts that have accessed the resource in the past duration of time and are no longer accessing the resource. In one example, the graphical representation may comprise a chart and the adjacent visual elements may be adjacent consecutive non-overlapping bars aligned along a horizontal axis. The horizontal axis may have a length that indicates a quantity of user accounts associated with a group. The user accounts may be student accounts and the group may be a class of students. In another example, the processing device may identify the source of the resource and may display the source along with the graphical representation. The source of the resource may be at least one of a web site, a remote file repository or a local file repository.

At block 640, the processing device may flag a selected activity of one or more user accounts. In one example of flagging, the processing device may receive a selection of one of the graphical representations and provide for display the user accounts that have accessed the resource corresponding to the selected graphical representation. The processing device may also receive a selection of one of the user accounts that have accessed the resource and initiating a flagging operation to capture content from the user's device. Flagging may involve capturing a screen shot on a user device associated with the selected user account and storing activity that occurred prior to and after a flagging operation.

At block 650, the processing device may terminate activity of a user or a user's access to a resource. This may involve identifying a user account in view of the graphical representations, wherein the user account is associated with at least one of the user devices and transmitting a request to at least one of the user devices to terminate the activity. The request may result in the generation of a close event for the resource or application (e.g., resource viewer 122).

Responsive to completing the operations described herein above with references to block 650, the method may complete.

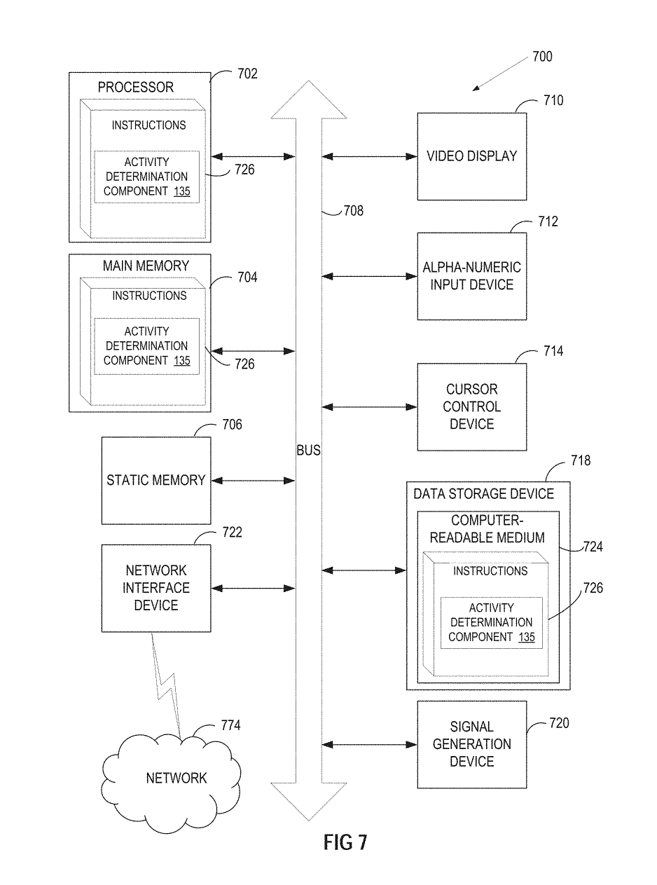

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 may be comprised of a processing device 702, a main memory 704 (e.g., read-only memory (ROM), flash memory, dynamic random access memory (DRAM) (such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. Processing device 702 is configured to execute processing logic 726 for performing the operations and steps discussed herein.

Computer system 700 may further include a network interface device 708. Computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

Data storage device 718 may include a machine-readable storage medium (or more specifically a computer-readable storage medium) 728 having one or more sets of instructions (e.g., software 722) embodying any one or more of the methodologies or functions described herein. For example, software 722 may store instructions for managing a trust. Software 722 may also reside, completely or at least partially, within main memory 704 and/or within processing device 702 during execution thereof by computer system 700; main memory 704 and processing device 702 also constituting machine-readable storage media. Software 722 may further be transmitted or received over a network 720 via network interface device 708.

Machine-readable storage medium 728 may also be used to store instructions for managing a trust. While machine-readable storage medium 728 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

Whereas many alterations and modifications of the present invention will no doubt become apparent to a person of ordinary skill in the art after having read the foregoing description, it is to be understood that any particular embodiment described and shown by way of illustration is in no way intended to be considered limiting. Therefore, references to details of various embodiments are not intended to limit the scope of the claims, which in themselves recite only those features regarded as the invention.

What is claim is:

1. A computer implemented method, comprising:
receiving a plurality of events indicating activity related to a resource, wherein each event is associated with a user account and comprises an action related to the resource;
aggregating the plurality of events based on the resource; and
providing a graphical user interface comprising one or more graphical representations of the aggregated plurality of events, wherein a graphical representation indicates a quantity of user accounts having activity related to the resource.

2. The computer implemented method of claim 1, wherein the resource comprises at least one of a web page, a textual document, or a video and the action related to the resource comprises at least one of an open event, an access event, a viewing event, an editing event or a closing event.

3. The computer implemented method of claim 1, wherein the graphical representation represents a total number of user accounts having activity related to the resource during a preselected duration of time, the preselected duration of time being equal to the duration of a class period.

4. The computer implemented method of claim 1, wherein the graphical representation comprises multiple adjacent visual elements, a first visual element representing a quantity of user accounts that are currently accessing the resource and a second visual indicator indicating a quantity of user accounts that have accessed the resource within a predetermined duration of time and are no longer accessing the resource.

5. The computer implemented method of claim 1, wherein the graphical representation comprises a chart and the adjacent visual elements are bars aligned along a horizontal axis, the horizontal axis having a length that indicates a quantity of user accounts associated with a group, the group being a group of students within a class.

6. The computer implemented method of claim 1, wherein the graphical representations comprise a first graphical representation illustrating the user accounts accessing a web page resource and a second graphical representation illustrating the user accounts accessing a textual document resource.

7. The computer implemented method of claim 1, further comprising identifying the source of the resource and displaying the source along with the graphical representation, wherein the source of resource is at least one of a web site, a remote file repository or a local file repository.

8. The computer implemented method of claim 1, wherein the graphical user interface comprises a first region that displays the graphical representations and a second region that displays each user account associated with a selected graphical representation, wherein the second region comprises, for each respective user account, at least one of: a name of the user account, a name of the resource, a name of the source of the resource, an event, or a relative time of the event.

9. The computer implemented method of claim 1, further comprising:
receiving a selection of one of the graphical representations;
providing for display, the user accounts having activity represented by the selected graphical representation;
receiving a selection of one of the user accounts; and
flagging activity of the selected user account, wherein the flagging initiates a capture of a screen shot of the activity of the selected user account.

10. The computer implemented method of claim 1, further comprising:
initiating a flag operation for a user account having activity related to the resource, wherein the flag operation involves storing a snapshot that comprises a screen shot of a user device and events that occurred prior to initiating the flag operation.

11. The computer implemented method of claim 1, further comprising:
transmitting a request to at least one of the user devices to terminate the activity related to the resource, wherein the request results in the generation of a close event for the resource.

12. A computer system, comprising:
a memory; and
a processing device communicatively coupled to the memory, the processing device configured to:
receive a plurality of events indicating activity related to a resource, wherein each event is associated with a user account and comprises an action related to the resource;
aggregate the plurality of events based on the resource; and
provide a graphical user interface comprising one or more graphical representations of the aggregated plurality of events, wherein a graphical representation indicates a quantity of user accounts having activity related to the resource.

13. A non-transitory computer-readable storage medium programmed to include instructions that, when executed by a processing device, cause the processing device to:
receive a plurality of events indicating activity related to a resource, wherein each event is associated with a user account and comprises an action related to the resource;
aggregate the plurality of events based on the resource; and
provide a graphical user interface comprising one or more graphical representations of the aggregated plurality of events, wherein a graphical representation indicates a quantity of user accounts having activity related to the resource.
